(19) United States
(12) Patent Application Publication
(10) Pub. No.: US 2021/0053305 A1
(43) Pub. Date: Feb. 25, 2021

(54) MOLD FOR MOLDING WAFER LENS

(71) Applicant: AAC Optics Solutions Pte. Ltd., Singapore city (SG)

(72) Inventors: Peter Krohne Nielsen, Farum (DK); Niels Christian Roemer Holme, Farum (DK); Bingke Zhu, Shenzhen (CN); Zhengmin Banjamin Pan, L.A., CA (US)

(21) Appl. No.: 16/986,298

(22) Filed: Aug. 6, 2020

(30) Foreign Application Priority Data
Aug. 20, 2019 (CN) 201910770835.8

(51) Int. Cl. B29D 11/00; G02B 3/00

(52) U.S. Cl. CPC B29D 11/0048; B29L 2011/0016; G02B 3/0031

(57) ABSTRACT

Provided is a mold for molding a wafer lens, including an upper mold and a lower mold. The upper mold includes a first molding surface. The first molding surface includes first molding portions. The first molding portion includes a first recessed portion formed by recessing from the first molding surface. The lower mold matches the upper mold. The lower mold includes a second molding surface right facing the first molding surface. The second molding surface includes second molding portions. The second molding portion includes a first protrusion portion protruding from the second molding surface towards the first molding surface. The first molding portions and the second molding portions are disposed in one-to-one correspondence. The first molding portion further includes a second recessed portion formed by recessing from the first molding surface towards a direction facing away from the lower mold. The second recessed portion surrounds the first recessed portion.

### TECHNICAL FIELD

The present invention relates to the field of lens manufacturing technology, and more particularly, to a mold for molding a wafer lens.

### BACKGROUND

A basic process for manufacturing a lens is usually to distribute a material such as glass or resin into a surface of a lower mold, put an upper mold portion on a lower mold portion, cause a recessed surface and a convex surface to face each other to form a lens-shaped lens cavity, and then cut a lens formed within the lens cavity into individual lenses or use the lens directly.

During the manufacturing process, due to a large radial flow of the material, bubbles, cracking, lack of filler and the like will occur to the lens, which affects a quality of the lens.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present invention. Moreover, in the drawings, like reference numerals designate corresponding parts throughout the several views.

FIG. 1 is a structural schematic diagram of a mold for molding a wafer lens according to an embodiment of the present invention;

FIG. 2 is an enlarged diagram of Portion a in FIG. 1;

FIG. 3 is a structural schematic diagram of an upper mold;

FIG. 4 is a cross-sectional diagram taken along line A-A in FIG. 3; and

FIG. 5 is an enlarged diagram of Portion b in FIG. 4;

### REFERENCE NUMERAL

1—upper mold;
11—first molding surface;
111—first recessed portion;
112—second recessed portion;
113—connecting portion;
2—lower mold;
21—second molding surface;
211—first protrusion portion;
3—lens.

### DESCRIPTION OF EMBODIMENTS

The present invention will be further illustrated with reference to the accompanying drawings and the embodiments.

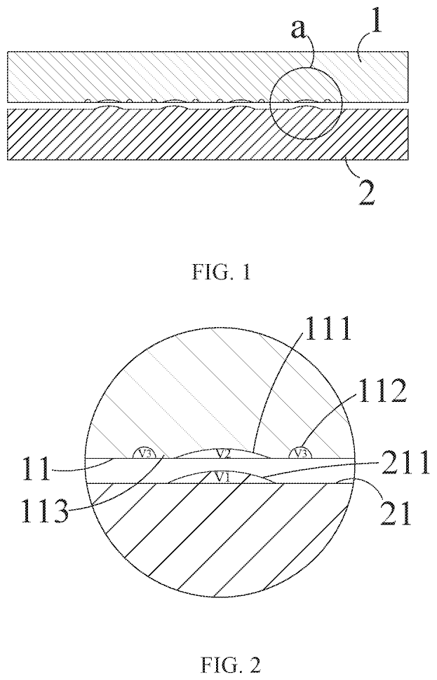

As shown in FIG. 1 and FIG. 2, a mold for molding a wafer lens provided by the present embodiment includes an upper mold 1 and a lower mold 2, and the upper mold 1 includes a first molding surface 11. The first molding surface 11 includes a plurality of first molding portions. The first molding portion includes a first recessed portion 111 formed by recessing from the first molding surface 11. The lower mold 2 correspondingly matches the upper mold 1, and the lower mold 2 includes a second molding surface 21 right facing the first molding surface 11. The second molding surface 21 includes a plurality of second molding portions. The second molding portion includes a first protrusion portion 211 formed by protruding from the second molding surface 21 towards the first molding surface 11. The first molding portion and the second molding portion are disposed in one-to-one correspondence. A material of a lens 3 can be formed into a shape of the lens 3 by the formed molding portions of the upper mold 1 and the lower mold 2. The upper mold 1 includes a plurality of first molding portions, and the first molding portion is provided with a first recessed portion 111. A shape of a top surface of the first recessed portion 111 is the same as a shape of an optical top surface of the lens 3. The lower mold includes a plurality of second molding portions, and the second molding portion is provided with a first protrusion portion 211. The first protrusion portion 211 has the same shape as an optical bottom surface of the lens 3. The first molding portion and the second molding portion can form a cavity, and a shape of the cavity complements a shape of the lens 3 to be fabricated. The first molding portion further includes a second recessed portion 112 formed by recessing from the first molding surface 11 towards a direction facing away from the lower mold 2. The second recessed portion 112 is disposed around the first recessed portion 111. By providing the second recessed portion 112, a volume of a cavity of the upper mold 1 can be appropriately compensated, such that the volume of the cavity in the upper mold 1 is close to a volume of a protrusion on the lower mold 2, thereby reducing a volume difference between the upper mold 1 and the lower mold 2 and thus preventing a large amount of material from flowing to a center of the first recessed portion 111. Namely, a radial material flow can be reduced to make a radial flow be close to zero, so as to eliminate technical problems that might affect the quality of the lens 3, such as bubbles, cracking, lack of filler in the lens 3 and the like.

In addition, due to the reduction of the radial material flow, it is also possible to decrease a probability of technical problems such as occurrence of changes in a thickness on a wafer in the lens 3, astigmatism and shape errors on the lens 3, occurrence of streamlines on the lens 3, lack of filler in the cavity and the like, and wear of the surface and the layer of the lens 3 can also be reduced.

A geometrical axis of the first recessed portion 111 is the same as that of the first protrusion portion 211. When pressing using a mold, a direction of the geometric axis can be used as a baseline. When removing the mold, the same baseline is maintained, reducing a probability of occurrence of shape errors in the lens 3.

As shown in FIG. 2, a volume V1 of the first protrusion portion 211 satisfies: V1=V2+V3;

here,
V2 is a volume of the first recessed portion 111; and
V3 is a volume of the second recessed portion 112.

The volume V3 of the second recessed portion 112 can compensate for the volume of the cavity of the upper mold 1, such that a sum of the volume of the cavity of the upper mold 1, i.e., V2+V3, is equal to the volume V1 of the protrusion on the lower mold 2, and the radial material flow is zero flow, thereby eliminating the technical problems that might affect the quality of the lens 3, such as bubbles, cracking, lack of filler in the lens 3 and the like. Due to the reduction of the radial material flow, it is also possible to decrease a probability of technical problems such as occurrence of changes in a thickness on a wafer in the lens 3, astigmatism and shape errors on the lens 3, occurrence of streamlines on the lens 3, lack of filler in the cavity and the like, and wear of the surface and the layer of the lens 3 can also be reduced.

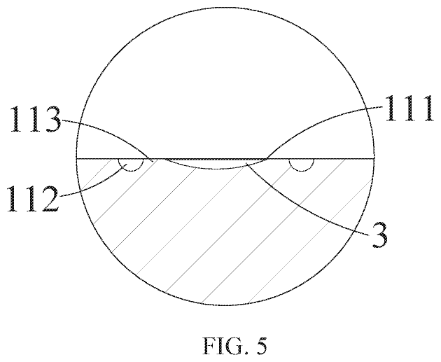

As shown in FIGS. 4 and 5, an inner surface of the second recessed portion 112 is a smooth curved surface, which reduces a probability of occurrence of changes in a thickness on a wafer in the lens 3, and so on.

In a specific embodiment, the second recessed portion 112 has an arc shape in cross section, making it possible to decrease a probability of occurrence of changes in a thickness on a wafer in the lens 3, astigmatism and shape errors on the lens 3, and occurrence of streamlines on the lens 3.

In a specific embodiment, the second recessed portion 112 symmetrically surrounds an outer circumference of the first recessed portion 111, preventing a large amount of material from flowing to the center of the first recessed portion 111. Namely, a radial material flow can be reduced to make a radial flow be close to zero, to reduce technical problems that might affect the quality of the lens 3, such as bubbles, cracking, lack of filler in the lens 3 and the like.

In a specific embodiment, the second recessed portion 112 has a continuous ring shape, preventing a large amount of material from flowing to the center of the first recessed portion 111. Namely, a radial material flow can be reduced to make a radial flow be close to zero, to reduce technical problems that might affect the quality of the lens 3, such as bubbles, cracking, lack of filler in the lens 3 and the like.

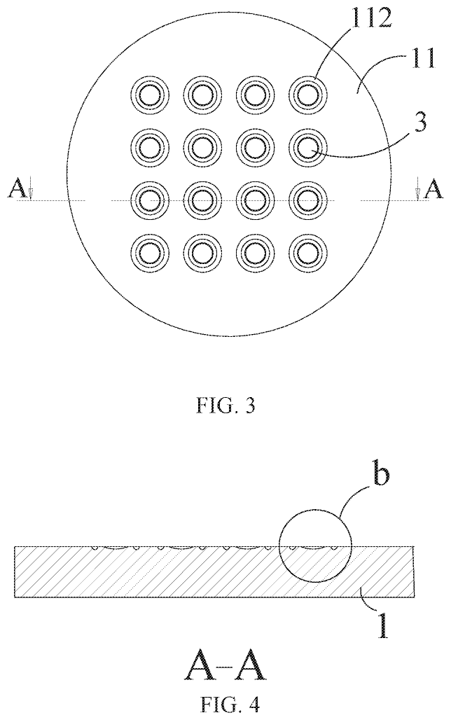

As shown in FIG. 3, a plurality of the first recessed portions 111 is arranged in a matrix, and a plurality of the second recessed portions 112 is arranged in a matrix. That is, the cavities for molding the lenses are arranged in a matrix, and a plurality of lenses 3 can be manufactured at the same time. The plurality of lenses 3 will be obtained by cutting after the completion of manufacturing. The arrangement of the cavities may be in a square pattern or a polygonal close-packed pattern.

In a specific embodiment, both the inner surface of the first recessed portion 111 and an outer surface of the first protrusion portion 211 are spherical, which is easy to process and results in an improved processing efficiency of the lens 3.

In a specific embodiment, the first recessed portion 111 is spaced apart from the second recessed portion 112. The first molding portion further includes a connecting portion 113 disposed between the first recessed portion 111 and the second recessed portion 112, which can increase an outward flow of the material, so as to reduce the radial material flow to make a radial flow be close to zero, thereby reducing technical problems that might affect the quality of the lens 3, such as bubbles, cracking, lack of filler in the lens 3 and the like.

In a specific embodiment, there is a smooth transition between the connecting portion 113 and the first recessed portion 111, and there is a smooth transition between the connecting portion 113 and the second recessed portion 112, so as to decrease a probability of occurrence of changes in a thickness on a wafer in the lens 3, astigmatism and shape errors on the lens 3, and occurrence of streamlines on the lens 3.

In a specific embodiment, the connecting portion 113 is in a ring shape, preventing a large amount of material from flowing to the center of the first recessed portion 111. Namely, a radial material flow can be reduced to make a radial flow be close to zero, so as to reduce technical problems that might affect the quality of the lens 3, such as bubbles, cracking, lack of filler in the lens 3 and the like.

The mold of the present embodiment of the present invention is merely an example, and the mold can be any mold capable of manufacturing a lens 3 having any combination including a concave optical surface or a convex optical surface.

What has been described above is only an embodiment of the present invention, and it should be noted herein that one ordinary person skilled in the art can make improvements without departing from the inventive concept of the present invention, but these are all within the scope of the present invention.

What is claimed is:

1. A mold for molding a wafer lens, comprising:
an upper mold comprising a first molding surface, the first molding surface comprising a plurality of first molding portions, and each of the plurality of first molding portions comprising a first recessed portion formed by recessing from the first molding face; and
a lower mold matching the upper mold, the lower mold comprising a second molding surface right facing the first molding surface, the second molding surface comprising a plurality of second molding portions, and each of the plurality of second molding portions comprising a first protrusion portion protruding from the second molding surface towards the first molding surface,
wherein the plurality of first molding portions and the plurality of second molding portions are disposed in one-to-one correspondence,
wherein each of the plurality of first molding portions further comprises a second recessed portion formed by recessing from the first molding surface towards a direction facing away from the lower mold, and the second recessed portion is disposed to surround the first recessed portion, and
a volume V1 of the first protrusion portion satisfies: V1=V2+V3, where V2 is a volume of the first recessed portion and V3 is a volume of the second recessed portion.

2. The mold for molding a wafer lens as described in claim 1, wherein an inner surface of the second recessed portion is a smooth curved surface.

3. The mold for molding a wafer lens as described in claim 1, wherein a cross section of the second recessed portion is of an arc shape.

4. The mold for molding a wafer lens as described in claim 1, wherein the second recessed portion symmetrically surrounds an outer circumference of the first recessed portion.

5. The mold for molding a wafer lens as described in claim 4, wherein the second recessed portion has a continuous ring shape.

6. The mold for molding a wafer lens as described in claim 1, wherein the first recessed portions of the plurality of first molding portions are arranged in a matrix; and
the second recessed portions of the plurality of first molding portions are arranged in a matrix.

7. The mold for molding a wafer lens as described in claim 1, wherein both an inner surface of the first recessed portion and an outer surface of the first protrusion portion are spherical.

8. The mold for molding a wafer lens as described in claim 1, wherein the first recessed portion is spaced apart from the second recessed portion, and each of the plurality of the first molding portions further comprises a connecting portion disposed between the first recessed portion and the second recessed portion.

9. The mold for molding a wafer lens as described in claim 8, wherein a smooth transition is formed between the connecting portion and the first recessed portion;
a smooth transition is formed between the connecting portion and the second recessed portion.

10. The mold for molding a wafer lens as described in claim 8, wherein the connecting portion has a ring shape.
